(19) United States
(12) Patent Application Publication
(10) Pub. No.: US 2008/0311372 A1
(43) Pub. Date: Dec. 18, 2008

(54) Use of UV Absorbers and Naphthalate Containing Polymers for Enhancing UV Stability of Fibers and Fabrics

(76) Inventor: Vaman G. Kulkarni, Charlotte, NC (US)

Correspondence Address: VORYS SATER SEYMOUR PEASE, 1828 L STREET NW, ELEVENTH FLOOR, WASHINGTON, DC, 20036, US

(21) Appl. No.: 12/141,888

(22) Filed: Jun. 18, 2008

Related U.S. Application Data
(60) Provisional application No. 60/929,227, filed on Jun. 18, 2007.

(51) Int. Cl. B32B 9/00; C08L 67/00; C08K 5/3412; C08K 5/04; C08K 5/3475; C08K 5/3492; C08K 3/22

(52) U.S. Cl. 428/221; 524/599; 524/86; 524/356; 524/359; 524/91; 524/100; 524/413; 524/432

(57) ABSTRACT

The present invention relates to the use of a blend of UV absorbers and a naphthalate containing polymer for enhancing the stability of fibers and fabrics. According to the present invention, preferred UV absorbers include but are not limited to benzophenones, benzotriazoles, triazines and benzoxazinone chemistries and preferred naphthalate containing polymers include but are not limited to polyethylene naphthalate (PEN), polyethylene naphthalate terephthalate (PENT), polybutylene naphthalate (PBN), polytrimethylene naphthalate (PTN) and copolymers and blends there of.

### RELATED APPLICATION

This application claims priority from U.S. Provisional Application No. 60/929,227, filed Jun. 18, 2007.

### FIELD OF THE INVENTION

The present invention generally relates to compositions for enhancing the ultraviolet (UV) stability of polymer fibers, fabrics and articles. More specifically, the present invention relates to thermoplastic polyesters and copolyester articles such as polyethylene terephthalate fibers and fabrics comprising a UV absorber and a naphthalate containing polymer. Such fibers and fabrics are useful in the automotive, boating, camping, public transit, and upholstery industries and the like, as well as in apparel and outdoor applications, such as in awnings, tents, umbrellas and the like.

### BACKGROUND OF THE INVENTION

Polyester fibers, fabrics and other articles exposed to sunlight undergo discoloration and degradation that severely affect the mechanical properties of the fibers, fabrics and articles such as tenacity and elongation.

UV absorbers such as benzophenones, benzotriazoles, triazines and benzoxazinones are the preferred stabilizers for host polymers such as polyesters, including polyethylene terephthalate (PET), and are used to combat the loss of mechanical properties. These UV absorbers protect the host polymer by absorbing the harmful UV radiation and dissipating it as thermal energy. A fundamental disadvantage of UV absorbers is the fact that they need a certain absorption depth (sample thickness) to protect the host polymer. In practice, high concentrations of absorbers and sufficient thickness of the host polymer are required before enough absorption takes place to effectively retard photo-degradation. Therefore, UV absorbers provide only limited protection to thin samples such as fibers, which typically range from about 12 to 40 microns in thickness, and thin films. Such stabilizers function according to the Beer-Lambert law, which specifies that the amount of UV radiation absorbed is a function of both sample thickness and stabilizer concentration. The effectiveness is also dependent on the extinction coefficient of the UV absorber. In packaging applications, where the packaging is sufficiently thick and one is concerned with protecting the contents of the package, UV absorbers work well.

Naphthalate containing polyesters are also known to provide UV blocking properties to PET. However, as with the UV absorbers listed above, such compounds are typically used in packaging to protect the contents of the packaging, as opposed to being used to protect the packaging, i.e., the article itself.

U.S. Pat. No. 5,989,794 discloses a polyalkylene naphthalate film, preferably the homopolymer of naphthalene-2,6-dicarboxylic acid and ethylene glycol (PEN), comprising a UV absorbing compound for quenching of the UV fluorescence at 429 nm. The polymeric film is preferably used as support for a photographic material, preferably a color negative or color reversal photographic material.

Accordingly, there remains a need for a composition that can offer UV stability, characterized by higher retention of mechanical properties such as tenacity and elongation, to PET fibers, fabrics and articles, especially in outdoor applications such as with awnings, tents, umbrellas, and the like or any other applications where the fiber or fabric is directly or indirectly exposed to UV light.

### SUMMARY AND OBJECTS OF THE INVENTION

It was surprisingly discovered that the UV stability of PET offered by a blend of a UV absorber and a naphthalate containing polymer was significantly higher than that of the individual components, indicating some sort of synergy.

It is therefore an object of the present invention to provide compositions for enhancing the UV stability of PET in packaging, films, fibers, fabrics and articles, including PET fibers and fabrics used in apparel, automotive, upholstery and outdoor applications.

It is another object of the present invention to provide polyester fibers with improved resistance to UV degradation despite the fine denier of the fiber.

It is yet another object of the present invention to provide a composition comprising a UV absorber such as a benzophenones, benzotriazoles, triazines, benzoxazinones and mixtures thereof and a naphthalate containing polymer.

It is yet another object of the present invention to provide a composition comprising a second UV absorber preferably a nano-compound.

It is yet another object of the present invention to provide a composition comprising about 0.1 to 50 parts by weight, preferably about 5 to 40 parts by weight, more preferably about 10 to 30 parts by weight, of the UV absorber and about 99.9 to 50 parts by weight of a naphthalate containing polymer.

It is yet another object of the present invention to provide a composition wherein the naphthalate containing polymer comprises polyethylene naphthalate (PEN), polyethylene naphthalate terephthalate (PENT), polybutylene naphthalate (PBN), polytrimethylene naphthalate (PTN) or copolymers or mixtures thereof, including polybutylene naphthalate terephthalate (PBNT) and polytrimethylene naphthalate terephthalate (PTNT).

It is a further object of the present invention to provide a composition comprising a UV absorber and a mixture of a naphthalate containing polymer and a thermoplastic polymer.

It is yet another object of the present invention to provide a composition wherein the mixture comprises about 10 to 90 parts by weight of the naphthalate containing polymer and about 90 to 10 parts by weight of the thermoplastic polymer, preferably about 80 parts by weight of the naphthalate containing polymer and 20 parts by weight of the thermoplastic polymer.

It is yet another object of the present invention to provide a composition wherein the thermoplastic polyester comprises polyethylene terephthalate, polybutylene terephthalate, polytrimethylene terephthalate and copolymers and mixtures thereof.

It is a further object of the present invention to provide a composition further comprising a second polymer such as PET or copolymers thereof.

It is yet another object of the present invention to provide a composition wherein the composition comprises about 0.1 to 5 parts by weight, preferably about 0.1 to 2 parts by weight, more preferably about 0.3 to 1.5 parts by weight, of the UV absorber, about 0.25 to 98 parts by weight, preferably about 0.5 to 20 parts by weight, more preferably about 0.2 to 10 parts by weight, of the naphthalate containing polymer, and about 99.65 to 0.1 parts by weight, preferably about 99.4 to 85 parts by weight, more preferably about 99.4 to 75 parts by weight, of the second polymer.

It is a further object of the present invention to provide an article such as a fiber, a fabric, a molded sheet or an extruded sheet, comprising a UV absorber and a naphthalate containing polymer.

It is a further object of the present invention to provide an article comprising a composition comprising a UV absorber and a mixture of a naphthalate containing polymer and a thermoplastic polymer.

It is a further object of the present invention to provide an article further comprising a polymer such as PET or copolymers thereof.

It is yet a further object of the present invention to provide a fabric comprising a first fiber and a second fiber, wherein the first fiber comprises a composition comprising a UV absorber and a naphthalate containing polymer.

It is yet a further object of the present invention to provide a fabric comprising a first fiber and a second fiber, wherein the first fiber comprises a composition comprising a UV absorber and a mixture of a naphthalate containing polymer and a thermoplastic polymer.

It is yet a further object of the present invention to provide a fabric further comprising a polymer such as PET or copolymers thereof.

It is yet a further object of the present invention to provide a fabric comprising a first fiber and a second fiber, wherein the first fiber comprises a composition comprising a UV absorber and a mixture of a naphthalate containing polymer and a thermoplastic polymer and the second fiber comprises a natural fiber such as cotton, wool, linen and silk, or a synthetic fiber such as polyester, nylon, polyolefin and acrylic.

It is still a further object of the present invention to provide a UV resistant article comprising an effective amount of UV absorber and an effective amount of a naphthalate containing polymer.

It is still a further object of the present invention to provide a UV resistant article comprising an effective amount of UV absorber and an effective amount of a mixture of a naphthalate containing polymer and a thermoplastic polymer.

It is still a further object of the present invention to provide a UV resistant article further comprising a polymer such as PET or copolymers thereof.

There has thus been outlined, rather broadly, the more important features of the invention in order that the detailed description of the preferred embodiments thereof that follows may be better understood, and in order that the present contribution to the art may be better appreciated. There are additional features of the invention that will be described hereinafter and which will form the subject matter of the claims appended hereto. The objects of the invention, along with the various features of novelty which characterize the invention, are pointed out with particularity in the claims annexed hereto and form part of the disclosure.

In this respect, before explaining at least one embodiment of the invention in detail, it is to be understood that the invention is not limited in its application to the details set forth in the following description, The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that equivalent compositions insofar as they do not depart from the spirit and scope of the present invention, are included in the present invention.

### DETAILED DESCRIPTION OF THE PREFERRED EMBODIMENT

According to the present invention, there are essentially two components that provide the host polymer with higher UV stability: a UV absorber and a naphthalate material. According to a further preferred embodiment, the composition further comprises a second UV absorber such as a nano-compound, preferably nano titanium dioxide (TiO2) or nano zinc oxide (ZnO).

As used herein, the term “host polymer” refers to a polymer, copolymer and mixtures thereof as well as materials made with the host polymer, wherein the host polymer is susceptible to UV degradation. According to the present invention, the host polymer can be any polymer. Preferably, however, the host polymer is a polyester resin, and more preferably, a polyethylene terephthalate (PET), copolymers and blends thereof. As used herein, the term copolymer has the meaning well know to one of skill in the art, i.e., a compound that imparts special property enhancements to melt point and crystallinity suppression, dye enhancement etc. Examples of such compounds includes but is not limited to isophthalic acid (IPA), diethylene glycol (DEG), cyclohexane dimethanol (CHDM) and other diacids, glycols and mixtures thereof. The host polymer may further contain coloring agents such as dyes and pigments that are well known in the art for coloring the host polymer.

The term “UV absorber” as used herein refers to chemical entities that protect UV sensitive material, such as the host polymer, by absorbing UV radiation and extending the useful life of the material. Any chemical entity that exhibits such UV absorption properties is within the scope of the present invention. Preferred UV absorbers include but are not limited to commercially available chemistries such as aliphatic or aromatic ketones, preferably benzophenones, more preferably hydroxyphenyl-benzophenones, benzotriazoles, preferably hydroxyphenyl-benzotriazole, cyclic aminoesters, preferably benzoxazinones, triazines, preferably hydroxyphenyl-s-triazine, cinnamic acid esters, cinnamate, cyanoacrylate, cyanosulfone, benzoates, benzoatecyanoester, oxanilide, oxalic acid amide, formamidine, salicylate compounds, preferably 4-t-butylphenylsalicylate or [2,2′thiobis-(4-toctylphenolate)]n-butylamine nickel (II), salicylic acid, hydroxyphenylpyrimidines, malonate compounds, preferably dimethyl p-methoxy-benzylidinemalonate, benzoxazin-4-one, hindered amine light stabilizers (HALS), nickel organic compounds, zinc compounds, and the like, but not limited to these. The UV absorber component in the present invention can be either a single material or combination of materials.

As used herein, the naphthalate material is characterized by a chemical or polymer made from naphthalene dicarboxylic acid. According to the present invention, preferred naphthalate material includes a polyalkylene naphthalate, homopolymers and copolymers thereof based on 2,6 naphthalene dicarboxylic acid and mixtures there of. Examples of preferred naphthalate polymers according to the present invention are polyethylene naphthalate (PEN), polybutylene naphthalate (PBN), polytrimethylene naphthalate (PTN) and copolymers of these with polyethylene terephthalate such as polyethylene naphthalate terephthalate (PENT) and other diacids and glycols that are well known in the art and blends and mixtures thereof.

In keeping with the spirit of the invention, while any combination of UV absorber and naphthalate are suitable for providing enhanced UV stability to the host polymer, suitable composition are those comprising from about 0.1 to 5 parts by weight of UV absorber and at least about 0.25%, preferably about 0.5% of the naphthalate polymer, with the balance being the host polymer. According to a preferred embodiment, composition comprises from about 0.1 to 2 parts by weight of the UV absorber and from about 0.1 to 10 parts by weight, preferably about 0.1 to 5 parts by weight, of the naphthalate polymer and from about 98.9 to 93 parts by weight, preferably about 98.9 to 88 parts by weight, of the host polymer. According to a further preferred embodiment, the composition comprises up to about 10 parts by weight of the naphthalate polymer.

According to the present invention, the UV absorber and the naphthalate polymer can be incorporated into the host polymer by various techniques that would be know to one of ordinary skill in the art. For example, a master batch of UV absorber and naphthalate polymer can be prepared first and then added to the host polymer by means of a dosing apparatus during extrusion. According to a preferred embodiment, the master batch also contains a second polymer, preferably a polyester polymer, copolymer and mixtures thereof. The master batch may further contain colorants and other additives designed to impart color and other properties to the host polymer in addition to the UV enhancing properties.

According to a preferred embodiment, the master batch comprises from about 5 to 50 parts by weight of the UV absorber and 95 to 50 parts of a first polymer mixture that comprises from about 99 to 1 parts by weight of a naphthalate polymer and 1 to 99 parts by weight of a second polymer. According to the present invention, the preferred naphthalate polymer is polyethylene naphthalate (PEN) or a copolymer of PEN. When a copolymer is used, the preferred copolymer is polyethylene naphthalate terephthalate (PENT), comprising from about 8 to 20 parts by weight terephthalate. According to the present invention, the preferred second polymer is polyethylene terephthalate (PET). The use of PENT allows for better processing of the master batch as well as metering of the master batch during use, at a lower temperature than PET alone. Further advantages in using PENT include minimizing the loss of UV absorber during processing and use of UV absorbers with lower thermal stability.

### EXAMPLES

The invention will now be further described in detail by descriptions of specific examples thereof. In the following examples and throughout this application, all parts and percentages are by weight.

### Samples

Sample A: a composition comprising 20 parts of benzoxazinone UV absorber and 80 parts of polyethylene terephthalate (PET) was prepared using a traditional extruder.

Sample B: a commercial composition of polyethylene naphthalate terephthalate (PENT) comprising an 80/20 ratio of naphthalate and terephthalate was obtained.

Sample C: a composition comprising 20 parts of benzoxazinone UV absorber and 80 parts of Sample B was prepared using a traditional extruder.

Sample D: polyethylene terephthalate (PET) fibers were spun according to the mixing ratios indicated below and weathered as per SAE J1960 accelerated weathering specification.

Sample D1: neat polyethylene terephthalate (PET).

Sample D2: 99 parts of polyethylene terephthalate (PET) and 1 parts of Sample B.

Sample D3: 98 parts of polyethylene terephthalate (PET) and 2 parts of Sample B.

Sample D4: 97 parts of polyethylene terephthalate (PET) and 3 parts of Sample B.

Sample D5: 95 parts of polyethylene terephthalate (PET) and 5 parts of Sample B.

Sample D6: 95 parts of polyethylene terephthalate (PET) and 5 parts of Sample A.

Sample D7: 95 parts of polyethylene terephthalate (PET) and 5 parts of Sample C.

Sample D8: 97.5 parts of polyethylene terephthalate (PET) and 2.5 parts of Sample C.

Example E: a composition comprising 20 parts of benzoxazinone UV absorber in 40 parts each of polyethylene terephthalate (PET) and Sample B was prepared using a traditional extruder.

Example F: polyethylene terephthalate (PET) fibers were spun according to the mixing ratios indicated below and weathered as per SAE J1960 accelerated weathering specification.

Sample F1: 95 parts of polyethylene terephthalate (PET) and 5 parts of Sample A.

Sample F2: 95 parts of polyethylene terephthalate (PET) and 5 parts of Sample E.

Sample F3: 97.5 parts of polyethylene terephthalate (PET) and 2.5 parts of Sample A.

Sample F4: 97.5 parts of polyethylene terephthalate (PET) and 2.5 parts of Sample E.

Sample G: a composition comprising a green color was prepared as would be well known to one of ordinary skill in the art.

Sample H: polyethylene terephthalate (PET) fibers were spun according to the mixing ratios indicated below and weathered as per SAE J1960 accelerated weathering specification.

Sample H1: the color composition of Sample G alone.

Sample H2: the color composition of Sample G and 5 parts of Sample A.

Sample H3: a color composition of Sample G and 2.5 parts of Sample C.

Sample I: a composition comprising 20 parts of benzotriazole UV absorber and 80 parts of polyethylene terephthalate (PET) was prepared using a traditional extruder.

Sample J: a composition comprising 20 parts of benzotriazole UV absorber and 80 parts of Sample B was prepared using a traditional extruder.

Sample K: polyethylene terephthalate (PET) fibers were spun according to the mixing ratios indicated below and weathered as per SAE J1960 accelerated weathering specification.

Sample K1: 95 parts of polyethylene terephthalate (PET) and 5 parts of Sample 1.

Sample K2: 95 parts of polyethylene terephthalate (PET) and 5 parts of Sample J.

Sample L: a composition comprising a red color was prepared as follows using a traditional extruder:
Sample L1: 34 parts of a red color (as would be well known to one of ordinary skill in the art), 1.1 parts of benzoxazinone UV absorber and 55 parts of polyethylene terephthalate (PET).
Sample L2: 34 parts of a red color (as would be well known to one of ordinary skill in the art), 11 parts of benzoxazinone UV absorber, 28 parts of polyethylene terephthalate (PET) and 27 parts of Sample B.

Sample M: polyethylene terephthalate (PET) fibers were spun according to the mixing ratios indicated below and weathered as per SAE J1960 accelerated weathering specification.

Sample M1: 9 parts of Sample L1 and 91 parts of polyethylene terephthalate (PET).

Sample M2: 9 parts of Sample L2 and 91 parts of polyethylene terephthalate (PET).

Sample N: a composition comprising a nano-compound was prepared as follows using a traditional extruder:
Sample N1: 11.25 parts of a black color (as would be well known to one of ordinary skill in the art), 12.5 parts of benzoxazinone UV absorber, and 76.25 parts of polyethylene terephthalate (PET).
Sample N2: 11.25 parts of a black color (as would be well known to one of ordinary skill in the art), 12.5 parts of benzoxazinone UV absorber, 50 parts of Sample B, and 26.25 parts of polyethylene terephthalate (PET).
Sample N3: 11.25 parts of a black color (as would be well known to one of ordinary skill in the art), 12.5 parts of benzoxazinone UV absorber, 6 parts of nano-TiO₂, 44 parts of Sample B, and 26.25 parts of polyethylene terephthalate (PET).

Sample O: polyethylene terephthalate (PET) fibers were spun according to the mixing ratios indicated below and weathered as per SAE J1960 accelerated weathering specification.

Sample O1: 8 parts of Sample N1 and 92 parts of polyethylene terephthalate (PET).

Sample O2: 8 parts of Sample N2 and 92 parts of polyethylene terephthalate (PET).

Sample O3: 8 parts of Sample N3 and 92 parts of polyethylene terephthalate (PET).

### RESULTS

The effect of accelerated weathering on properties of polyethylene terephthalate is shown in Table 1. As shown in Table 1, polyester undergoes considerable degradation even at 250 hours exposure. Further exposure results in a rapid deterioration in properties and an undesirable product. Table 2 shows the effect of the addition of a naphthalate polymer at various levels. It is surprising to note that despite the UV absorbing properties of the naphthalate polymer at these levels, there is a negative effect on the mechanical properties of polyethylene terephthalate fiber. Table 3 shows the effect of the present invention for enhancing the stability to UV. The results clearly indicate the superior properties offered by the composition of the present invention.

TABLE 1
Effect of weathering as per SAE J1960 on Sample D1.

| | % Tenacity Retention | % Elongation Retention |
|---|---|---|
| Unweathered PET | 100 | 110 |
| Weathered PET | | |
| 250 Hours | 43 | 72 |
| 500 Hours | 14 | 4 |
| 750 Hours | 9 | 7 |

TABLE 2
Effect of weathering per SAE J1060 on Samples D2-D5.

| | Exposure Hours | | | | | |
|---|---|---|---|---|---|---|
| | 0 | | 500 | | 750 | |
| | % | % | % | % | % | % |
| | Tenacity | Elongation | Tenacity | Elongation | Tenacity | Elongation |
| | Retention | Retention | Retention | Retention | Retention | Retention |
| Unweathered PET | 100 | 110 | | | | |
| Weathered PET | | | 14 | 4 | 9 | 7 |
| Sample D2 | | | 14 | 2 | 9 | 2 |
| Sample D3 | | | 12 | 16 | 7 | 3 |
| Sample D4 | | | 14 | 3 | 6 | 3 |
| Sample D5 | | | 9 | 42 | 7 | 2 |

TABLE 3
Effect of weathering per SAE J1960 on Samples D6-D8.

| | Exposure Hours | | | | | |
|---|---|---|---|---|---|---|
| | 0 | | 250 | | 750 | |
| | % | % | % | % | % | % |
| | Tenacity | Elongation | Tenacity | Elongation | Tenacity | Elongation |
| | Retention | Retention | Retention | Retention | Retention | Retention |
| Unweathered PET | 100 | 110 | | | | |
| Weathered PET | | | 43 | 72 | 9 | 7 |
| Sample D6 | | | 77 | 122 | 25 | 3 |
| Sample D7 | | | 96 | 130 | 49 | 84 |
| Sample D8 | | | 70 | 114 | 22 | 60 |

TABLE 4
Effect of weathering per SAE J1960 on Samples F1-F4.

| | Exposure Hours | | | | | |
|---|---|---|---|---|---|---|
| | 0 | | 500 | | 750 | |
| | % | % | % | % | % | % |
| | Tenacity | Elongation | Tenacity | Elongation | Tenacity | Elongation |
| | Retention | Retention | Retention | Retention | Retention | Retention |
| Unweathered PET | 100 | 110 | | | | |
| Weathered PET | | | 14 | 4 | 9 | 7 |
| Sample F1 | | | 49 | 95 | 25 | 3 |
| Sample F2 | | | 58 | 87 | 52 | 87 |
| Sample F3 | | | 27 | 42 | 17 | 3 |
| Sample F4 | | | 41 | 76 | 39 | 81 |

TABLE 5
Effect of weathering per SAE J1960 on Samples H1-H3.

Exposure Hours
500

| | % Tenacity Retention | % Elongation Retention |
|---|---|---|
| Sample H1 | 25 | 3 |
| Sample H2 | 36 | 4 |
| Sample H3 | 44 | 76 |

TABLE 6
Effect of weathering per SAE J1960 on Samples K1-K2.

| | Exposure Hours | | | | | |
|---|---|---|---|---|---|---|
| | 0 | | 250 | | 750 | |
| | % | % | % | % | % | % |
| | Tenacity | Elongation | Tenacity | Elongation | Tenacity | Elongation |
| | Retention | Retention | Retention | Retention | Retention | Retention |
| Unweathered PET | 100 | 110 | | | | |
| Weathered PET | | | 43 | 72 | 9 | 7 |
| Sample K1 | | | 72 | 114 | 28 | 4 |
| Sample K2 | | | 87 | 128 | 37 | 88 |

TABLE 7
Effect of weathering per SAE J1960 on Samples M1-M2.

| | Exposure Hours | | | | | | | |
|---|---|---|---|---|---|---|---|---|
| | 250 | | 500 | | 750 | | 1000 | |
| | % | % | % | % | % | % | % | % |
| | Tenacity | Elongation | Tenacity | Elongation | Tenacity | Elongation | Tenacity | Elongation |
| | Retention | Retention | Retention | Retention | Retention | Retention | Retention | Retention |
| Sample | 70 | 136 | 54 | 112 | 48 | 106 | 37 | 80 |
| M1 | | | | | | | | |
| Sample | 82 | 152 | 67 | 135 | 58 | 122 | 51 | 104 |
| M2 | | | | | | | | |

TABLE 8
Effect of weathering per SAE J1960 on Sample O1-O3.

| | Exposure Hours | | | | | | | |
|---|---|---|---|---|---|---|---|---|
| | 250 | | 500 | | 750 | | 1000 | |
| | % | % | % | % | % | % | % | % |
| | Tenacity | Elongation | Tenacity | Elongation | Tenacity | Elongation | Tenacity | Elongation |
| | Retention | Retention | Retention | Retention | Retention | Retention | Retention | Retention |
| Sample O1 | 77 | 134 | 66 | 120 | 52 | 96 | 47 | 95 |
| Sample O2 | 89 | 129 | 75 | 119 | 60 | 108 | 54 | 95 |
| Sample O3 | 83 | 123 | 74 | 121 | 60 | 109 | 51 | 103 |

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be made to the described embodiments without departing from the true scope and spirit of the subject invention as defined by the appended claims.

What is claimed is:

1. A composition comprising a UV absorber, a first polymer and a second polymer, wherein the first polymer comprises at least one naphthalate containing polymer.

2. The composition of claim 1, wherein the UV absorber is selected from the group consisting of aliphatic ketones, aromatic ketones and cyclic aminoesters.

3. The composition of claim 1, wherein the UV absorber is selected from the group consisting of benzophenones, benzotriazoles, triazines, benzoxazinones and mixtures thereof.

4. The composition of claim 1, wherein the naphthalate containing polymer comprises a naphthalate containing polyester.

5. The composition of claim 4, wherein the naphthalate containing polyester is selected from group consisting of polyethylene naphthalate, polyethylene naphthalate terephthalate, polybutylene naphthalate, polytrimethylene naphthalate and copolymers and mixtures thereof.

6. The composition of claim 1, wherein the first polymer comprises a mixture of a naphthalate containing polymer and a thermoplastic polymer.

7. The composition of claim 6, wherein the mixture comprises about 10 to 90 parts by weight of the naphthalate containing polymer and about 90 to 10 parts by weight of the thermoplastic polymer.

8. The composition of claim 6, wherein the thermoplastic polymer comprises a thermoplastic polyester.

9. The composition of claim 8, wherein the thermoplastic polyester is selected from the group consisting of polyethylene terephthalate, polybutylene terephthalate, polytrimethylene terephthalate and copolymers and mixtures thereof.

10. The composition of claim 1, wherein the composition comprises about 0.1 to 50 parts by weight of the UV absorber, about 0.5 to 98 parts of the first polymer, and about 99.4 to 0.1 parts by weight of the second polymer.

11. The composition of claim 1, wherein the second polymer is selected from the group consisting of a polyethylene terephthalate and copolymers thereof.

12. The composition of claim 1, further comprising a second UV absorber selected from the group consisting of nano TiO₂ and nano ZnO.

13. An article comprising the composition of claim 1.

14. The article of claim 13, wherein the article comprises a fiber, a fabric, a molded sheet or an extruded sheet.

15. A UV resistant article comprising an effective amount of UV absorber and an effective amount of a first polymer, wherein the first polymer comprises at least one naphthalate containing polymer.

16. The article of claim 15, wherein the UV absorber is selected from the group consisting of benzophenones, benzotriazoles, triazines, benzoxazinones and mixtures thereof.

17. The article of claim 15, wherein the naphthalate containing polymer comprises a naphthalate containing polyester.

18. The article of claim 17, wherein the naphthalate containing polyester is selected from group consisting of polyethylene naphthalate, polyethylene naphthalate terephthalate, polybutylene naphthalate, polytrimethylene naphthalate and copolymers and mixtures thereof.

19. The article of claim 15, wherein the first polymer comprises a mixture of a naphthalate containing polymer and a thermoplastic polymer.

20. The article of claim 19, wherein the thermoplastic polymer comprises a thermoplastic polyester.

21. The article of claim 20, wherein the thermoplastic polyester is selected from the group consisting of polyethylene terephthalate, polybutylene terephthalate, polytrimethylene terephthalate and copolymers and mixtures thereof.

22. The article of claim 15, wherein the composition further comprises a second polymer.

23. The article of claim 22, wherein the second polymer is selected from the group consisting of a polyethylene terephthalate and copolymers thereof.

24. The article of claim 15, wherein the article comprises a fiber, a fabric, a molded sheet or an extruded sheet.

25. A fabric comprising a first fiber and a second fiber, wherein the first fiber comprises the article of claim 15.

26. The fabric of claim 25, wherein the second fiber comprises a natural fiber or a synthetic fiber.

27. The fabric of claim 26, wherein the natural fiber is selected from the group consisting of cotton, wool, linen and silk.

28. The fabric of claim 26, wherein the synthetic fiber is selected from the group consisting of polyester, nylon, polyolefin and acrylic.

29. A composition comprising a compound selected from the group consisting of benzophenones, benzotriazoles, triazines, benzoxazinones and mixtures thereof, a first polymer and a second polymer, wherein the first polymer comprises at least one naphthalate containing polyester selected from group consisting of polyethylene naphthalate, polyethylene naphthalate terephthalate, polybutylene naphthalate, polytrimethylene naphthalate and copolymers and mixtures thereof and the second polymer is selected from the group consisting of a polyethylene terephthalate and copolymers and mixtures thereof.

30. The composition of claim 29, wherein the first polymer comprises a mixture of a naphthalate containing polymer and a thermoplastic polyester selected from the group consisting of polyethylene terephthalate, polybutylene terephthalate, polytrimethylene terephthalate and copolymers and mixtures thereof.

31. An article comprising the composition of claim 29.

32. The article of claim 31, wherein the article comprises a fiber, a fabric, a molded sheet or an extruded sheet.
